(19) United States
(12) Patent Application Publication
(10) Pub. No.: US 2006/0038455 A1
(43) Pub. Date: Feb. 23, 2006

(54) Finger exercise apparatus

(76) Inventor: Robert Allen Pavwoski, Lansing, MI (US)

Correspondence Address: VARNUM, RIDDERING, SCHMIDT & HOWLETT LLP, P.O. BOX 352, GRAND RAPIDS, MI, 49501, US

(21) Appl. No.: 11/208,195

(22) Filed: Aug. 19, 2005

Related U.S. Application Data
(60) Provisional application No. 60/603,267, filed on Aug. 23, 2004.

(51) Int. Cl. H02K 23/60

(52) U.S. Cl. 310/120

(57) ABSTRACT

A finger exerciser apparatus has a frame with a wrist end and an opposite finger end. The apparatus may be attached at the wrist end to a user's hand, wrist or forearm with the frame extending beyond and generally in a plane with the user's extended fingers to the finger end. One or more individual finger bands are provide to a user's fingers. At least one clip is attached to an interior of the frame at the finger end. Each clip is adapted to releasably hold a finger band and each finger band comprises a ring that is adapted to releasably attach to a clip. A strip extends from the ring to a sleeve that has a hollow bore that extends through at least about half of a length of the sleeve.

### CROSS-REFERENCES TO RELATED APPLICATIONS

This application is based on and claims the benefit of the filing date of applicant's co-pending provisional Patent Application No. 60/603,267, filed Aug. 23, 2004, which is incorporated herein by reference.

### BACKGROUND OF INVENTION

The present invention relates to an improved finger exerciser that provides improved versatility in the exercise or rehabilitation of an injured finger or fingers. Individuals often injure their fingers. A number of devices have been developed to assist with exercise or rehabilitation of fingers. Many of these are complicated or awkward. On the other hand, other devices are too simplistic to provide physical activity that is tailored for a person's need or injury. The present invention provides a cost-effective and easy-to-use finger exerciser that is versatile enough to provide targeted therapy for multiple injuries or areas of the finger.

### BRIEF SUMMARY OF THE INVENTION

In accordance with the present invention, an improved finger exerciser comprises a frame, an arm strap and at least one finger band. The frame and arm strap permit a user to attach the apparatus to the arm such that an opposite end of the frame extends beyond the user's extended fingers. At least one clip is attached to the interior of the frame at the end opposite the arm strap. Each clip has an aperture capable of holding a finger band. In one aspect of the invention, there are four clips attached to the interior of the frame, each positioned relative to the location of a finger. Each finger band attaches to the clip by sliding a ring at the end of the finger band through the aperture and over the clip.

The finger band includes a flexible strip that reaches from the ring attached to the clip to a finger band sleeve that holds a finger. In one aspect of the invention, the width of the strip at the point of attachment to the ring is substantially similar to the width of the ring and the width of the strip at the point of attachment to the sleeve is substantially similar to the length of the sleeve. In another aspect of the present invention, the exterior of the finger band sleeve has ribs that reach around the circumference of the sleeve. The sleeve is flexible and can be deflected to different positions, so that the sleeve can fit on different joints of a finger. The sleeves thus can be used on fingers that have been partially amputated.

One of the advantages of the present invention is that the product is cost effective yet versatile. Individual finger bands can be sized to fit a variety of finger sizes and with varying tensions, such that a patient can receive targeted exercise as is necessary for treatment. Because the frame and arm strap portions are easy to attach to the arm, any such therapy can take place at a patient's home or elsewhere without supervision. Because different fingers may need different therapy, a variety of finger bands may be used with little or no change over time necessary. Also, finger bands can extend from any clip to any finger, so that the direction of the resilient stress on a finger can be adjusted.

These and other advantages and features of the present invention will become apparent from a description of the preferred embodiment of the present invention, which is described in detail below and shown in the appended drawings.

### BRIEF DESCRIPTION OF THE DRAWING

FIG. 1 is a perspective view of the frame assembly portion of the present invention.

FIG. 2 is a fragmentary perspective view illustrating in detail a clip of the present invention.

FIG. 3 is a perspective view of a finger band of the present invention.

FIG. 4 is a perspective view of the present invention with a hand in the rested position.

FIG. 5 is a perspective view of the present invention with the index finger of a hand in the active or exercising position.

FIG. 6 is the view of FIG. 4, showing the finger band anchored to an alternative frame clip.

### DESCRIPTION OF PREFERRED EMBODIMENT

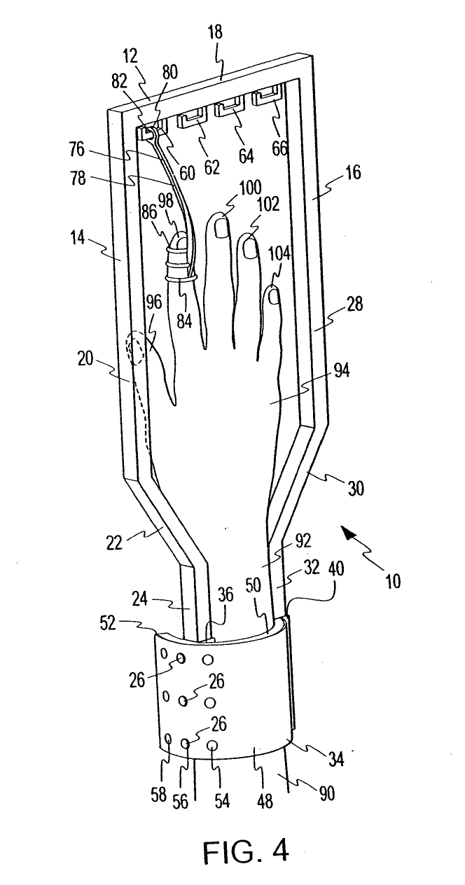

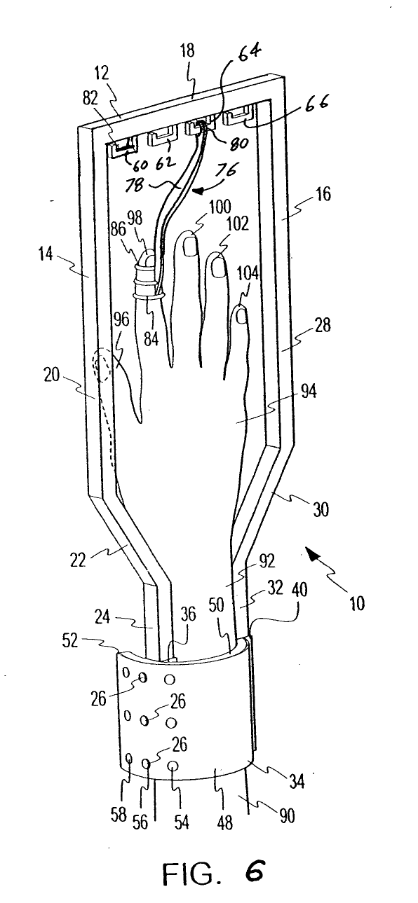

Referring to FIG. 4 a finger exerciser 10 is shown in cooperation with a hand 94. The finger exerciser includes a frame assembly 12 that is fixed to the user's wrist 92 or forearm 90 by an arm strap 34. One or more finger bands 76 are attached to the frame 12 by sliding a finger band ring 80 at one end of the finger band over one of four finger clips 60, 62, 64, or 66. A finger band sleeve 84 at the opposite end of the finger band 76 fits around a preselected finger, the index finger 98 of hand 94 in the illustrated embodiment. Any of the fingers of a hand can be exercised individually or as a group in a similar manner by connecting a band 76 to the appropriate finger band clip 60, 62, 64, or 66 for the selected finger. A user's fingers can be connected to a finger band opposite the finger as shown in FIG. 4, or the finger can be connected to a finger band attached to a different clip (e.g., clips 62, 64, or 66) when resilient resistance from a different direction is desired as shown in FIG. 6.

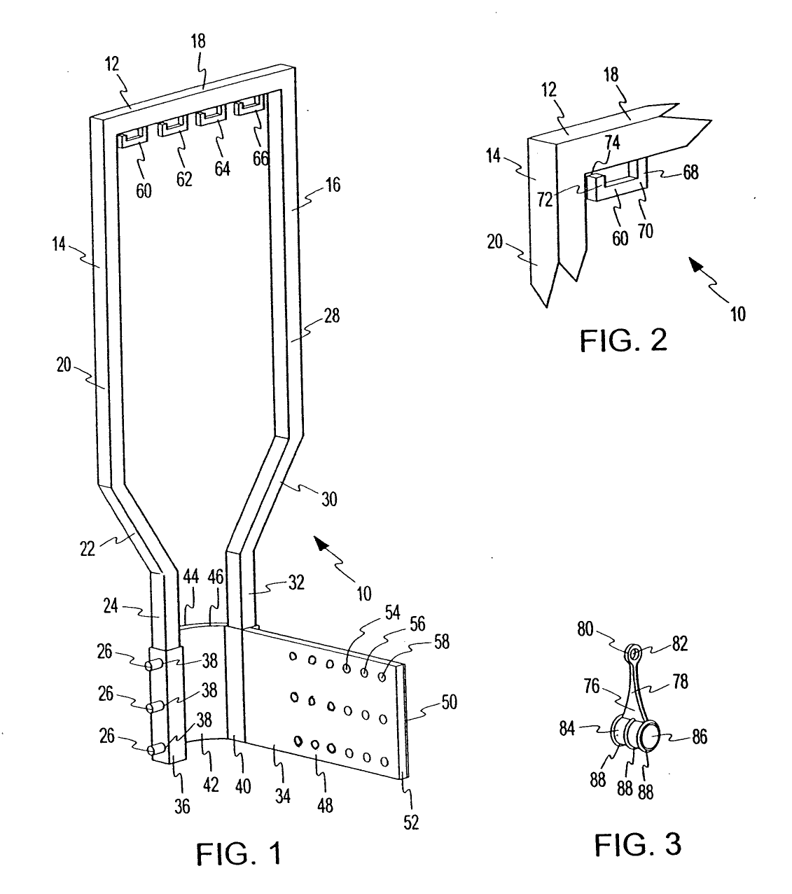

Referring now to FIG 1, the finger exerciser 10 consists of the frame 12 and the arm strap 34. The frame 12 is comprised of material that is lightweight, durable, rigid, yet able to flex without snapping, resistant to corrosion, oxidation and the like, such as plastic, fiberglass, composite materials, and ferrous and non-ferrous metals such as tubular or solid brass or aluminum. Brass is desirable because it is corrosion resistant and ductile, so it resists stress hardening. The finger exerciser 10 of the present invention attaches to the user's hand, wrist, or forearm and positions the user's hand relative to the clips 60, 62, 64, and 66 that hold the finger bands 76. In a preferred embodiment, the finger exerciser 10 attaches to the user's wrist or forearm by way of an arm strap 34.

The arm strap 34 is located at the bottom of the finger exerciser 10, specifically at the attachment members 24, 32 of the side members 14 and 16 of the frame 12, respectively. The arm strap 34 is comprised of a first sleeve 36 with a series of apertures 38 located on one side thereof and a second sleeve 40. The sleeves 36, 40 are fitted over and receive the attachment members 24, 32, respectively, thereby securing the strap 34 to the frame. Protuberances 26 of the attachment member 24 of the first side member 14 extend through respective apertures 38 of the first sleeve 36. A first, fixed section 42 of the strap 34 is located between the sleeves 36, 40 with a first side of the section 42 attached to the first sleeve 36 and a second side of the fixed section 42 attached to the second sleeve 40.

The fixed section 42 is comprised of an outer layer of flexible, liquid-impervious material 44, such as plastic, and in inner layer of flexible, shock-absorbent material 36, such as sponge or padding. A second, foldable section 48 is attached at one side thereof to one side of the second sleeve 40 and extends therefrom for a distance sufficient to reach the protuberances 26 extending from cooperating attachment member 24. The foldable section 48 is also comprised of an outer layer 50 of flexible, liquid-impervious material, such as plastic, and in inner layer of flexible, shock-absorbent material 52, such as sponge or padding. First aperture row 54, second aperture row 56 and third aperture row 58, for example, are located proximate to the unconnected end of the foldable section 48 and extend through the outer layer 50 and inner layer 52. The number of rows of apertures may be indefinite and subject to adjustment needs relative to the adjustment needs of the strap 34 and specifically the foldable section 48.

The apertures of each row 54, 56, 58 and other rows as desired, may be aligned to receive in snug engagement cooperating protuberances 26 when the foldable section 48 is folded over the attachment members 24, 32 of the frame 12 to secure the finger exerciser 10 to the arm of a user. As such, the foldable section 48 permits the arm strap 34 to be adjusted to three or more positions or sizes as indicated by the spacing of the rows 54, 56, 58, for example, of apertures so as to accommodate various sized arms of different users or arms that may be covered with bandages, dressings or casts. For instance, the strap 34 may be adjusted to a medium opening or size by placing the first row of apertures 54 over the protuberances 26, a larger opening or size by placing the second row of apertures 56 over the protuberances 26, or the largest opening or size by placing the third row of apertures 58 over the protuberances 26. Additional flexibility in adjusting the size of the apparatus 10 can be provided by flexing the side members 14, 16 inward or outward with respect to the top member 18. It is noted that while the protuberances 26 are specifically shown as cylindrical members that extend from the frame attachment member 24, the protuberances 26 may alternatively include a spherical catch portion or the like, at a terminal end of each protuberance 26 to secure the foldable section 48 from unintentionally disengaging from the protuberances 26. Those of ordinary skill in the art will also recognize that many alternative attachment methods may also be utilized in the present invention, such as a hook and loop fastener like Velcro, clips, buttons, or similar devices.

Attachment members 24 and 32 extend from the arm strap 34 and sleeves 36 and 40 to connect with clearance members 22 and 30, respectively. Clearance members 22 and 30 angle outward from the attachment members 24 and 32, which are positioned parallel to each other. Clearance member 22 then attaches to hand extension member 20 while clearance member 30 attaches to hand extension member 28. Hand extension members 20 and 28 are parallel to each other and allow clearance for a fully extended hand within the finger exerciser 10. Together, attachment member 24, clearance member 22, and hand extension member 20 form the first side member 14. Similarly, attachment member 32, clearance member 30, and hand extension member 28 form the second side member 16. End member 18 connects the first side member 14 and a second side member 16 at the ends of hand extension 20 and hand extension 28.

First clip 60, second clip 62, third clip 64 and fourth clip 66 are attached to the frame 12 at the underside of the top side member 18 thereof. While the four clips 60-66 may be found to be a typical arrangement, the invention anticipates use of other than only four clips. The clips 60, 62, 64, 66 may be identical in shape, appearance, and construction. As shown, each clip 60, 62, 64, 66 is designed to correspond to one of four fingers of a hand when a hand is situated within the finger exerciser 10. As shown in detail in FIG. 2, the first clip 60 is comprised of a first member 68, a second member 70, and a third member 72. The first member 68 is connected at a first end thereof to the underside of the top side member 18 and extends therefrom for some distance in perpendicular relation to the longitudinal axis of the top side member 18. The second member 70 is connected at a first end thereof to a second end of the first member 68 and extends therefrom in perpendicular relation. The third member 72 is connected at a first end thereof to a second end thereof to the second member 70 and extends therefrom in perpendicular relation for some distance. The first 68 and third 72 members of the clip 60 are disposed in parallel relation, and the second member 70 of the clip 60 and the top side member 18 are disposed in parallel.

The third member 72 extends only partially from the second member 70 at a distance less than that of the first member 68. As such, a gap or opening 74 is located between the unconnected end of the third member 72 and the bottom side of the top side member 18. Each of the remaining clips 62, 64, 66 is constructed as that of the first clip 60 so that a gap or opening 74 is located between the unconnected end of the third tubular member 72 of each clip and bottom side of the top side member 18.

Referring to FIG. 3, therein illustrated is a finger band 76, said finger band 76 able to receive therein an end of a finger of a hand situated within the frame 12 of the finger exerciser apparatus 10 when said band 76 is releasably attached to one of the clips 60, 62, 64, 66. The finger band 76 is comprised of a strip 78, ring 80 enclosing an aperture 82, and a cylindrical sleeve 84. The ring 80 is attached to the strip 78 at a first, narrower end of the strip 78, and the sleeve 84 is attached to a second, wider end of the strip 78. The sleeve 84 encloses a bore 86 that extends longitudinally through the sleeve 84. A series of circular ribs 88 is located on the sleeve 84 at opposed ends and middle section of said sleeve 84. The finger band 76 is fabricated of soft, flexible, resilient material that can flex and yield to various positions yet return to it is original configuration after pressure or force urging it to a flexed position is released, reduced, or withdrawn.

In FIG. 4, a forearm arm 90 of a patient or user is located within the frame 12 of the finger exerciser 10. More specifically, the wrist 92 of said forearm 90 is situated between the attachment members 24, 32 of first and second side members 14 and 16, respectively, of said frame 12, and the hand 94 of said user is located within the space enclosed by the clearance members 22 and 30, hand extension members 20 and 28, and top side member 18. The forearm 90 and wrist 92 are secured within the frame 12 by the strap 34 of which the foldable or second section 48 is folded from the second sleeve 40 over the forearm 90 and wrist 92 so that the unconnected end of the second section 48 meets the first sleeve 36. The unconnected end of the second section 48 is secured to the frame 12 by aligning a row of apertures, row 56 for example, with the protuberances 26 and pressing the unconnected end of the second section 48 toward the sleeve 36 and attachment member 24 enclosed therein so that the protuberances 26 occupy cooperating apertures within the second row 56 of apertures. As such, the forearm 90 and wrist 92 are secured in snug engagement within the strap 34 between first 36 and second 40 sleeves and first 42 and second 48 sections of said strap 34.

The thumb 96 and four fingers 98, 100, 102, 104 of the hand 94 are generally disposed in an extended position within the frame 12 with the index finger 98 aligned under the first clip, second finger 100 aligned under the second clip 62, third finger 102 aligned under the third clip 64, and fourth finger 104 aligned under the fourth clip 66. In this example, the finger band 76 is attached to the index finger 98 and first clip 60 so as to maintain the index finger 98 in an upright, vertical position and to return the finger 98 to said position after exercising and physical therapy of said finger 98. The finger band 76 is situated on the clip 60 by passing the ring 80 through the gap or opening 74 located between the third tubular member 72 of the clip 60 and bottom side of the top side member 18 so that the aperture 82 of the ring 80 receives the second member 70 of the clip 60. Once the ring 80 is positioned on the second member 70 as such said ring 80 is prevented from sliding off the clip 60 by opposed first 68 and third 72 members thereof. The strip 78 is stretched as necessary to allow the sleeve 84 connected thereto to reach the finger 98 tip, at which point the finger 98 tip is inserted into the bore 86 of the sleeve 84 until said finger 98 tip fully occupies the bore 86 and is secured in snug engagement within said sleeve 84. The resilient action of the strip 78 contracts said strip 78 and urges the sleeve 84 and finger 98 tip secured therein towards the clip 60 so that the finger 98 is maintained in a generally upright, extended position.

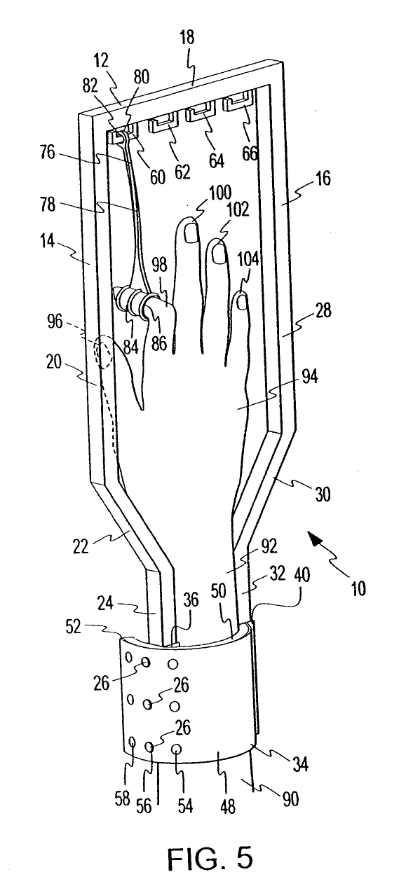

As illustrated in FIG. 5, the index finger 98 secured within the finger band 76 can be exercised or strengthened under a physical therapy routine by flexing the finger 98 downward away from the clip 60. The finger 98 can flex downward under its own power or with the aid of a physical therapist at either the first or second knuckles or combination of said knuckles. The resilient action of the strip 78 provides resistance to the downward motion of the finger 98 so that muscles and tissues of the finger or hand 94 proper are properly exercised and eventually strengthened and rehabilitated to their optimum condition. Once the finger 98 is flexed downward to the fullest extent necessary or possible, muscle action within the finger 98 and hand 94 can be relaxed, and the finger 98 can be re-positioned to its initial, upright position either by means of muscle action of the index finger 98 or hand 94 or with the aid of the resilient action of the strip 78 of the finger band 76. This process can be repeated as many times as permissible to provide a proper exercise or physical therapy regimen with the goal of being able to flex the finger 98 downward to reach the palm of the hand 94. Similarly, the remaining fingers 100, 102, 104 of the hand 94 can be rehabilitated in this manner, either individually or in conjunction with one or more fingers 98, 100, 102, 104. Alternatively, lateral rehabilitation exercise may be accommodated merely by relocating the ring 80 of the finger band 76 from the respective aligned clip 60 in this example to a selected one of the other clips (FIG. 6). This may also be accommodated in other than single finger exercising as indicated above. Furthermore, the exercise and physical therapy regimens can be intensified with use of finger bands 76 possessing increasing levels of resistance.

While this version of the invention has been illustrated and described in detail in the drawings and foregoing description, the same is to be considered as illustrative and not restrictive in character, it being understood that only a preferred embodiment has been shown and described and that all changes and modifications that come within the spirit of the version of the invention are desired to be protected. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. In a finger exerciser apparatus having a wrist end and an opposite finger end, wherein the apparatus may be attached at the wrist end to a user's hand, wrist or forearm and a frame extends beyond and generally in a plane with the user's extended fingers to the finger end, an improvement for providing one or more individual finger bands to a user's fingers, the improvement comprising at least one clip attached to an interior of the frame at the finger end, with each clip being adapted to releasably hold a finger band, each finger band comprising a ring that is adapted to attach to said clip, a strip that extends from the ring to a sleeve, said sleeve having a hollow bore that extends through at least 50% of the length of the sleeve.

2. A finger exerciser as in claim 1 wherein the finger band has a sleeve with a length of 2 inches or less and a bore diameter of 1 inch or less.

3. A finger exerciser as in claim 2 wherein the finger band has a strip with a width at a point of attachment to the ring that is substantially similar to the width of the ring and a width at a point of attachment to the sleeve that is substantially similar to the length of the sleeve.

4. A finger exerciser as in claim 1 wherein the finger band sleeve has ribs around a circumference of the sleeve.

5. A finger exerciser as in claim 1 wherein four clips are attached to the interior of the frame at the finger end.
